(19) United States
(12) Patent Application Publication
(10) Pub. No.: US 2014/0246375 A1
(43) Pub. Date: Sep. 4, 2014

(54) Electrochemical-based reactor for the removal of free cyanides and iron cyanide from industrial wastewater

(71) Applicants: Hamed Gharibi, Tehran (IR); Amir Hossein Mahvi, Tehran (IR)

(72) Inventors: Hamed Gharibi, Tehran (IR); Amir Hossein Mahvi, Tehran (IR)

(21) Appl. No.: 13/783,328

(22) Filed: Mar. 3, 2013

(51) Int. Cl. C02F 1/463

(52) U.S. Cl. CPC C02F 1/463
USPC 210/721

(57) ABSTRACT

The present invention relates to a continuous bipolar electrochemically based reactor for the purpose of destroying free cyanide by direct and indirect oxidation and removing its strong complexes like ferrocyanide and ferricyanide by electrocoagulation. The designed reactor consists of four main sections, including electrooxidation, hydraulic mixing, electrocoagulation, and precipitation tank. The order of sections results in having a combination of reactions which separately remove cyanide and its compounds. The designed reactor shows a high flexibility in terms of handling highly variable kinds and concentrations of cyanide in the industrial wastewater effluents.

### FIELD OF THE INVENTION

This invention relates to a continuous bipolar electrochemically based reactor for the purpose of destroying free cyanide by direct and indirect oxidation and removing its strong complexes like ferrocyanide and ferricyanide by electrocoagulation. The reactor consists of four main sections including electrooxidation, hydraulic mixing, electrocoagulation, and precipitation tank. In fact, the invention relates to a combination of reactions which separately remove cyanide and its compounds from industrial wastewater effluents; in the other words, the combination increases the flexibility of the reactor in terms of handling highly variable kinds and concentration of cyanide in the industrial wastewater effluents. Although cyanide removal by electrochemical technologies has been proposed by other researchers and inventors, the present invention relates to a combination of consequent reactions which their interrelationships enhance cyanide removal efficiency in a way which separate the present invention from the earlier ones. By providing suitable anodes for both electrooxidation and electrocoagulation sections, selecting appropriate current density, adjusting pH, and using a reductive agent at the hydraulically mixing section, the inventors provided a reactor in which cyanide and its compounds are efficiently removable through consecutive reactions in the reactor. Due to the highly variable forms of cyanide in the industrial wastewater effluents, the inventors designed a reactor in which cyanide, regardless of its kind, can be efficiently removed.

### BACKGROUND OF THE INVENTION

So far, cyanide has been extensively applied in various industries which, in turn, significant amounts of that, through the industrial wastewater effluents, have been released into the environment in the various forms such as free cyanide and its complexes with metallic compounds. Cyanide toxicity is proven in terms of human health and biota; also, its degree of toxicity varies from one form of cyanide to another one. For example, free cyanide (CN⁻ and HCN) and iron cyanide (ferricyanide and ferrocyanide) are known as the most and the least toxic forms of cyanide, respectively. Regarding their toxicity, recent studies have shown that even the least toxic forms of cyanide can be accounted as a threat to human and aquatic organisms when they are dissociated under UV radiation to free cyanide. The kind of cyanide in the effluent is dependent to different conditions, but it can be found mainly in complex forms with other metallic compounds. In addition, cyanide concentration in the effluent varies from an industry to another one. In fact, cyanide, its kind and concentration, is highly variable in the industrial wastewater effluents. According to these conditions, the present invention is capable of handling and removing cyanide and its compounds from the effluents by a bipolar continuous electrochemically-based reactor with a minimum usage of chemical compounds.

U.S. Pat. No. 8,093,442 B2 [1] describes an electrochemical based-method by which highly stable metal cyanide ions can be destroyed. To have the suitable efficiency, the inventors claimed that the anode surface should be covered with a passivation layer, and also the pH should be adjusted at 9-11.5. However, the efficiency decreases when that method is applied for the effluents which have high concentrations of Cl⁻, because this ion has negative impacts on the passivation layer. In addition, it is proven that where electrooxidation is applied for treating wastewater, due basically to the existence of Cl⁻ at almost all the wastewater effluents, the formation of by-products is also probable. Furthermore, the invention is just able to destroy ferrocyanide among the highly stable forms of iron cyanide. Hence, where ferricyanide is present along with the other forms of cyanide, the invention is not able to destroy it. Another disadvantage of the invention is that at the alkaline pH the cyanide ions readily make bound with metallic compounds. In the other words, cyanide ions may react with ferric ions which results in the formation of ferricyanide. In the operational terms, the invention needs to be carefully checked in terms of pH, and any change at the pH would result in the decrease of efficiency which, in turn, some amounts of cyanide could be discharged into the environment. In a worse case, cyanide released at this stage can adversely affect the precipitation of heavy metals via increasing their solubility.

U.S. Pat. No. 3,816,275 [2] describes an electrolyzing process with iron plate as anode by which ferrocyanide and ferricyanide can be removed from waste liquor. These difficultly decomposable forms of cyanide make bound with the released iron ions which results in the formation of “Prussian Blue”, then surface as scum. The major drawback of this invention is that when the aim is removing all the forms of cyanide by just iron ions, the consumption of iron significantly increases, which in turn necessitates prompt replacement of the plates; besides, the volume of the produced sludge increases.

U.S. Pat. No. 4,312,760 [3] describes a method for removing cyanide (free or as a metal-complex) by adding ferrous bisulfite to the cyanide-contained wastewaters. This invention turns all the forms of cyanide as free cyanide and iron cyanide into the blue colloids of “Prussian Blue”, hence high amounts of ferrous ions are needed and also the produced sludge should be carefully disposed of. In addition, it is needed to add chemical compounds such as “ferrous bisulfite” to the wastewater, which is costly in terms of its price and the need for storage.

U. Bakir Ogutveren et al., [4] studied the feasibility of a bipolar trickle tower electrochemical reactor to remove cyanide from the effluent. In this study, they use Rasching rings as electrode. The results indicate that the reactor is able to effectively remove cyanide as free cyanide from the effluent.

Furthermore, extensive methods have been proposed to remove cyanide and its compounds from the effluents, including alkaline chlorination, INCO process, and electrooxidation. However, the current methods are not able to remove all forms of cyanide from the effluents, therefore, necessitating complementary processes.

### SUMMARY OF THE INVENTION

This invention relates to a process in which four main sections, including electrooxidation, hydraulic mixing, electrocoagulation, and precipitation are consecutively set up as a continuous, packed reactor, which is shown in FIG. 1, in order to remove cyanide and its compounds.

At the first section, i.e. electrooxidation, indirect and direct oxidation of cyanide compounds, except difficultly decomposable ones such as iron cyanide compounds, with hypochlorite ions at pH>10 occurs; and the section comprises Ruo₂/Ti and stainless still as the anode and cathode, respectively, which only one pair is connected to the DC power. If needed, pH should be adjusted at pH>10, preferably between 10-11, by adding an acid or base to the influent of the reactor. Unlike the former electrochemically based methods, this invention uses the normal concentration of chloride ion, which is naturally present in the wastewater effluents (according to the previously conducted studies, the inventors have found that the normal concentration of chloride in wastewater ranges between 800 and 1000 ppm).

The effluent of the first section, which its free cyanide content is destroyed, reaches the second section, hydraulic mixing one; where the wastewater is subjected to the injection of SO₂ in order to lower the pH, neutralize the possibly formed by-products such as the remaining of hypochlorite ions from the first section, and the rest of free cyanide ions in a case that the efficiency of the first section due to operational problems decreases. In fact, it is realistic that a process's efficiency decreases over time due to several problems, which in this case are sudden increase of cyanide concentration, corrosion of the anode surface over the operational periods, and decrease in the concentration of chloride ions are the reasons which may pose problems to the reactor's efficiency. Therefore, this middle section is a part in which the decreased efficiency of the electrooxidation section, due to said reasons, can be compensated. Besides, this section provides a place where the abnormal increase of the solution's temperature, which is due to subjecting the solution to electrooxidation process, can be controlled. Unlike the former proposed methods in this field, the present invention not only handles the by-products of chloride ions, but also has the flexibility to control any sudden changes in the wastewater contents in terms of cyanide and chloride ion concentrations.

When the effluent of the second section reaches the third one, i.e. electrocoagulation, its free cyanide content is completely destroyed and due mainly to the addition of SO₂, its pH is lowered to the acidic conditions. As known to all, at acidic conditions, HCN, which is one of the most toxic forms of cyanide, is produced. Taking the safety into consideration, the top of the two acidic sections, hydraulical mixing and electrocoagulation, is covered in order to prevent the release of the possibly formed HCN, though its production is quite unlikely because of the destruction of free cyanide as well as addition of SO₂.

By passing electrical current through the iron plates, at the third section, iron ions are released into the wastewater, said wastewater comprises iron cyanide compounds such as ferrocyanide and ferricyanide; and blue colloidal particles known as “Prussian Blue” particles form in said section. Unlike the former methods and processes in this field, the present invention removes cyanide and its compounds step-by-step from the effluent; in the other words, the reactor is built in a way to be capable of separating the distinct forms of cyanide from the effluent. Consequently, the consumption of chemical compounds, such as SO₂ and iron ions, is considerably reduced. Additionally, this separation enables us to apply less current in the second section, because part of the cyanide is already removed in the prior section; this highly reduces the costs of electricity and decreases the corrosion of the plates. To have suitable results, the pH should be adjusted to a pH between 3-5.

The effluent of the third section, which is in fact the influent of the forth section, is subjected afterward to the addition of a base, preferably NaOH, in order to increase the pH to a pH between 8-10; then, ferric hydroxide form in the section which results in sweeping formed blue colloidal particles, then precipitate. The chain of reactions in the reactor completely removes cyanide and its complexes from the wastewater. In fact, each section not just removes some forms of cyanide, but also plays an important role in terms of positive impacts on the other sections in the reactor. By this combination, there is no need to add extra amounts of chloride to the wastewater, the problems of forming by-products of indirect oxidation of cyanide by hypochlorite ions is solved, there is no need to use high concentrations of SO₂, just strong forms of cyanide turn into the colloidal blue particles not all the forms of cyanide in the effluent, and finally this combination increases the flexibility of the reactor in terms of handling different forms of cyanide in the effluent. The above said advantages cannot be achieved by applying only a single process, as observed in the previous inventions.

### BRIEF DESCRIPTION OF THE FIGURE

FIG. 1 shows the reactor which consists of EO reactor (18 liter in volume), hydraulically mixing section (9 liter in volume), EC reactor (18 liter in volume), and precipitation tank (27 in volume). The baffles at the beginning of the EO and EC reactor are set out to equalize the influent velocity to the related sections. Ruo₂/Ti and stainless still plates are used in EO reactor as anode and cathode, respectively; also, iron plates are used as electrode in the EC reactor. In addition, each plate has the effective surface area of 200 cm² (20 cm×10 cm), and the space between the plates is 8 mm. At each section, only a pairs of plates is connected to the DC power supply.

### DETAILED DESCRIPTION OF THE INVENTION

In the cyanide-contained wastewater effluents, cyanide is present at various forms and concentrations. In fact, its form is strongly related to metallic compounds and the condition of the wastewater in terms of pH. Hence, it is expected that a process must handle these situations, because the remained cyanide not just has negative impacts on the environment, but also results in the increase of heavy metals solubility in the wastewater. As a matter of fact, cyanide has various forms which are classified as free cyanide, weak acid dissociable and strong acid dissociable. Regarding these classes, the hard part of removing cyanide is that different forms of cyanide need different conditions to be removed. For example, iron cyanide compounds need different processes and conditions so as to be removed, compared to the other forms of cyanide. Due mainly to this fact, the operators either need to have extra processes to handle this situation which increases the costs or to avoid some parts of cyanide and let those to be released into the environment. This invention relates to complete cyanide removal from the effluents, regardless of its forms. In fact, the combination of reactions in the reactor and also the positive impact of each section on the other sections results in the removal of cyanide and its compounds in a way that is not feasible by just using a single reaction.

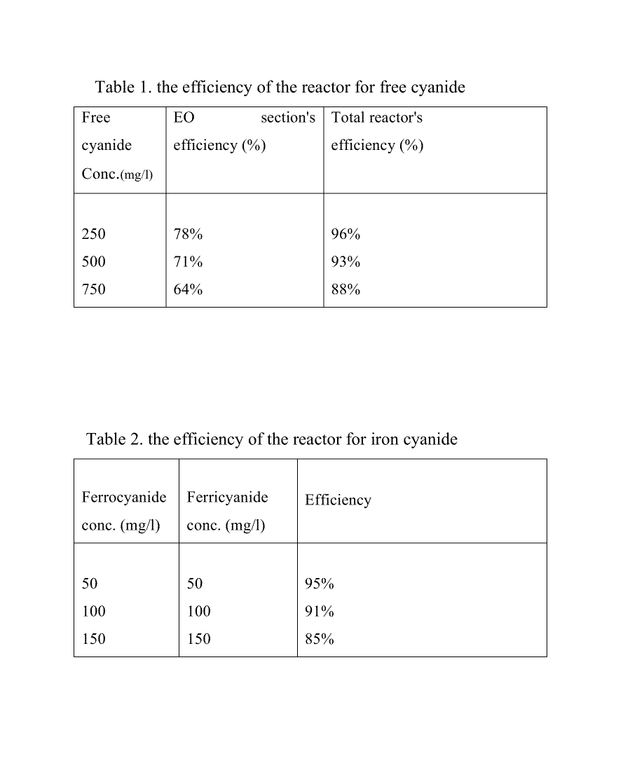

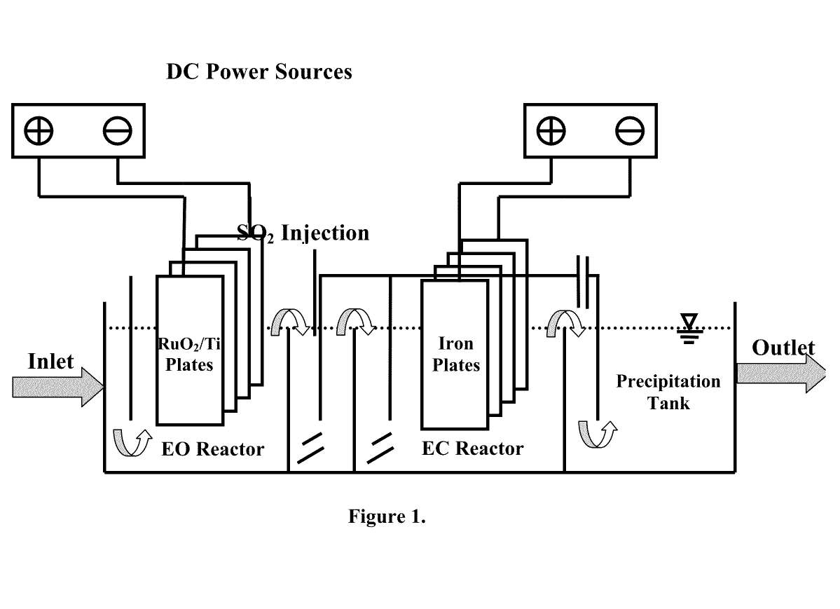

As can be seen in FIG. 1, the cyanide-contained wastewater firstly meets the electrooxidation section. In addition, it is expected that pH of the wastewater is >10 (preferably between 10-11) or, if required, it should be adjusted by an acid and/or a base; also, said wastewater is expected to have chloride ions. In this section, free cyanide can be oxidized at the anode surface as direct oxidation and the bulk solution as indirect oxidation, according to the following reactions:

### Anodic Reactions:

2H₂O→4H⁺+O₂(g)+4e⁻ (1)

2Cl⁻→Cl₂+2e⁻ (2)

C₂N₂+2OH⁻→CNO⁻+CN⁻+H₂O (3)

Cathodic reactions:

2H₂O+2e⁻→H₂(g)+2OH⁻ (4)

At the bulk solution:

Cl₂+H₂O→HOCl+H⁺+Cl⁻ (5)

HOCl→OCl⁻+H⁺ (6)

CN⁻+OCl⁻+H₂O→CNCl+2OH⁻ (7)

Cl₂+CN⁻→CNCl+Cl⁻ (8)

CNCl+2OH⁻→CNO⁻+Cl⁻+H₂O (9)

CNO⁻+2H₂O→NH₄⁺+CO₃⁻² (10)

2CNO⁻+3OCl⁻+H₂O→2CO₃⁻²+NH₂+3Cl⁻ (11)

According to the above reactions, cyanide is oxidized by direct and indirect oxidation to cyanate (CNO⁻); according to equations 10 and 11, further reactions decompose the cyanate. Considering indirect oxidation, chlorine plays an important role in free cyanide oxidation and due to regeneration of it at the anode surface; it serves as catalyst in the bulk solution. As known to all, chloride ions are almost the inseparable part of wastewater contains. Hence, applying electrochemical technologies could produce harmful by-products which cannot be avoided. Besides, passing electricity through a solution increases its temperature that should be controlled. By reaching the second section of the reactor, it is expected that the strong forms of cyanide such as ferricyanide and/or ferrocyanide are the only cyanide compounds, which are left to be removed. Preparing the solution in order to remove said iron cyanide by making reaction with released ferrous and ferric ions from the anode surface in the third section needs to decrease the pH to a pH between 3 and 5. Therefore, the wastewater is subjected to the injection of SO₂, which contributes to the decrease of pH by the formation of acids in the solution; also, SO₂ immediately turns to SO₃⁻² (known as “Sulfurous Acid”), which is a reducing agent and reduces the OCl⁻ in the solution. Although the reaction of SO₂, at the second section, with the solution happens very fast, this section is also intended to serve another purpose which is reducing the increased temperature of the solution during electrooxidation; so, this section is set up in a way that provides an appropriate detention time for the wastewater so as to cool it down. By passing through the hydraulical mixing section, the acidified wastewater reaches the third section, i.e. electrocoagulation.

Acidic pH plays an important role, because it prevents the formation of ferric hydroxide [Fe (OH)₃] in this section; hence, released ferric (Fe⁺³) ions from the anode surface undergoes chemical reactions with the iron cyanide compounds, which results in the formation of colloidal blue particles in the bulk solution. The inventors found out that the rate of ferric ions release is directly connected to the applied current density. In the other words, higher current density means having a higher concentration of Fe⁺³ in the bulk solution. However, higher current density increases the consumption of the iron anodes. It is noteworthy that since this section is only related to the removal of iron cyanides, there is no need to apply the high current density necessary for electrooxidation. This decreases the power consumption, and therefore, the operational costs. By treating wastewater in the third section, it is expected that said iron cyanide compounds turned to insoluble form which is known as “Prussian Blue”. As the wastewater enters the precipitation tank, its pH rises to a pH between 8 and 10 by adding NaOH to the solution. It results in the formation of ferric hydroxide flocs which sweep the formed colloidal blue particles from the solution and precipitate them at the bottom of the tank. Furthermore, the inventors found out that the precipitation of said flocs not only removes said particles, but also enhances the precipitation of heavy metals in the tank.

To have a full automatic reactor, the inventors recommend the usage of programmable controllers where the pH is needed to be adjusted, and also the injection of SO₂.

### EXAMPLES

### Example 1

Three concentrations of free cyanide using NaCN and iron cyanide using potassium ferrocyanide and potassium ferricyanide are prepared. Besides, all tests are performed with having 800-1000 ppm chloride ions, due mainly to have actual concentration of this ion in the synthetic wastewater. The wastewater which its pH is adjusted to a pH >10 by using NaOH (preferably between 10 and 11) passes through the first section, i. e. electrooxidation, with the flow rate of 10.8 L/h and current density of 20 mA/cm² at the anode surface. At the beginning of hydraulically mixing section, sulfur dioxide (SO₂) was added to prepare an acidic (pH 3-6) and reductive condition. SO₂ reacts with a variety of compounds in the bulk solution. The reaction of SO₂ with residual chlorine (OCl⁻) is done more quickly. Afterwards, SO₃⁻² reacts with ferricyanide and transforms it to ferrocyanide. Therefore, every increase in the ferrocyanide/ferricyanide ratio is a good indicator for the complete decomposition of residual chlorine in the bulk solution, and therefore the adequacy of SO₂ addition. In case ferricyanide does not exist in the wastewater, direct measurement of residual chlorine can be used to measure the adequacy of SO₂ addition. The efficiency of the electrooxidation tank is presented in table 1.

Afterwards, the wastewater enters the electrocoagulation tank with the same flow rate. The current density 15 mA/cm² is used at the anode surface. In this tank, iron ions released from the anode surface react with iron cyanide (ferrocyanide and ferricyanide) in acidic conditions, causing to formation of insoluble, colloidal particles. The efficiency of the electrocoagulation tank for the applied wastewater is given in table 2. Prior the precipitation tank, continuously NaOH addition to the EC effluent caused the rising pH to the >8.5 which, in turn, iron cyanide particles and also coagulants precipitate.

### Example 2

In this example, the performance of the reactor is tested under non-ideal conditions in terms of chlorine or cyanide concentrations. The chlorine concentration in this run is 400-500 mg/l, and that of free cyanide is 1500 mg/l. The operational conditions and iron cyanide concentrations are the same as those in example 1. The efficiency of the reactor for free cyanide removal under these conditions is 52% and 87% for the electrooxidation part and total reactor, respectively. As the result indicates, the efficiency of the EO section decreases due to the lack of optimal conditions, but the efficiency of the total reactor proves that the other sections control these situations in terms of decreases of chloride ions and increases of free cyanide concentration.

### Example 3

In this example, the performance of the reactor was tested under conditions in which the concentration of ferrocyanide and ferricyanide suddenly increase in wastewater. In this case, the concentration of ferrocyanide and ferricyanide are both changed to 300 mg/l. The operational conditions for other parameters are the same as those in example 1. The efficiency of the EC section for ferrocyanide and ferricyanide removal decreased to 68%, as it was expected. It is due to this reason that the ferrocyanide and ferricyanide removal's efficiency is related to the release of iron from the iron plates in EC section. When the current density 15 mA/cm², which was applied in example 1, was changed to 20 mA/cm², the removal efficiency increased to 83%. Although the power consumption increases in such conditions, this test also shows that the reactor is able to control the sudden increase of iron cyanide concentrations.

We claim:

1. A method for removing free cyanide and iron cyanide from wastewater (i. e. ferrocyanide and ferricyanide) in a reactor, comprising:
adjusting the pH>10 (preferably between 10 and 11) prior to an electro oxidation, wherein the free cyanide is removed by direct and indirect oxidation;
subjecting the wastewater to an injection of SO2 in order to lower the pH to 3-6 and to remove residual chlorine:
passing wastewater through a second section to meet an electro coagulation one at an acidified condition, wherein the iron cyanide goes under reaction with the released iron ions from the anode surface which results in the formation of blue colloidal particles;
adding a base to the wastewater when it is entering a precipitation tank, blue colloidal particles are swept by the formation of ferric hydroxide.

2. The method according to claim 1, wherein a continuous, bipolar, reactor is applied.

3. The method according to claim 1, wherein RuO2/Ti is applied as an anode in the electro oxidation.

4. The method according to claim 1, wherein a density of 5-25 mA/cm² is applied at the anode surface in the electrooxidation section.

5. The method according to claim 1, wherein the indirect oxidation is performed with the normal concentration of chloride ions in the wastewater.

6. The method according to claim 1, wherein the hydraulic mixing is set after electrooxidation section.

7. The method according to claim 5, wherein the solution is subjected to the injection of SO₂ in the hydraulic mixing section.

8. The method according to claim 5, wherein the residual chlorine as a by-product is destroyed by the injection of SO₂.

9. The method according to claim 5, wherein the SO₂ lowers the pH to 3-6 in the hydraulic mixing section.

10. The method according to claim 1, wherein the electrocoagulation process is set after the hydraulic mixing section.

11. The method according to claim 1, wherein the iron plates are applied as anodes in the electrocoagulation section.

12. The method according to claim 9, wherein ferrocyanide and ferricyanide are removed in the electrocoagulation tank.
